(19) United States
(12) Patent Application Publication
(10) Pub. No.: US 2006/0203786 A1
(43) Pub. Date: Sep. 14, 2006

(54) Cable-TV-based wireless network

(76) Inventor: Srinivas Kola, Saratoga, CA (US)

Correspondence Address: Clifton L. Anderson;C9 Networks, Suite 205, 341 Cobalt Way, Sunnyvale, CA, 94085, US

(21) Appl. No.: 11/155,713

(22) Filed: Jun. 17, 2005

Related U.S. Application Data
(60) Provisional application No. 60/580,560, filed on Jun. 17, 2004.

(51) Int. Cl. H04Q 7/24

(52) U.S. Cl. 370/338

(57) ABSTRACT

A computer network based on cable-TV distribution network employs a hybrid cable-modem termination service plus wireless-network switch to manage wireless clients that access the switch through wireless access points coupled to cable modems. The switch includes a network manager that associates wireless clients with cable modems so that services associated with a first cable modem can be switched to a second cable modem when a wireless user moves from the coverage area of a wireless access point coupled to the first cable modem to a coverage area of a wireless access point coupled to the second cable modem. In some cases, the switch can permit a user to roam from one coverage area to another without interrupting an ongoing interaction over the Internet. It also has the ability to keep the wireless traffic separate from the wired traffic.

### BACKGROUND OF THE INVENTION

This application claims the benefit of provisional application 60/580,560, filed Jun. 17, 2004.

The present application relates to wireless networks and, more particularly, to wireless networks that connect to a wide-area network and/or the Internet using a cable-TV connection. A major objective of the invention is to provide an economical wide-area wireless (or wired-plus wireless) network with roaming capability. Herein, related art labeled “prior art” is admitted prior art; related art not labeled “prior art” is not admitted prior art.

Over the last ten years, the Internet has emerged as an essential tool for communication, for transacting business, for following the news, and for entertainment. To avail themselves of media-rich content on the Internet, many subscribers have graduated from relatively slow “dial-up” connections to relatively fast “broadband” connections, e.g., digital subscriber lines (DSL) using phone-line-based connections and cable-TV connections. Increasingly, wireless access points and routers are attached to DSL modems and cable modems providing multiple clients wireless access to the Internet via the broadband connections.

In the meantime, cellular phone technology has engendered an expectation (that is realized to a limited extent) of mobile wireless voice communications. This in turn has generated a demand for mobile data communications and Internet connectivity. Cellular phone networks are being adapted to data communications, but progress is slow. Prevalent cellular connections provide only bandwidth comparable to dial-up connections. While cellular network providers are increasingly providing broadband cellular connections, broadband cellular remains constrained regionally, with full coverage not expected for years. In addition, broadband cellular access is expensive and only one phone can be used per account.

Several businesses, e.g., airports, hotels, restaurants, and cafes, are making low-cost or free wireless connections available to attract customers. These “hot spots” do provide data communications and Internet access for those away from the office or home, but coverage is inherently “spotty”. Major efforts are underway to develop city-wide wireless systems, e.g., WiMax, but these are requiring new standards to develop and new hardware installations. Furthermore, users will have to buy new equipment to take advantage of WiMax or any of its competitors. Thus, while there is a demand for affordable mobile broadband data communications and Internet access, there are still many obstacles to its realization.

### SUMMARY OF THE INVENTION

The present invention provides for mobile wireless broadband data communications and Internet access using a cable-TV hardware network as a communications backbone. A network manager manages plural cable modems as components of a roam-able virtual network. Preferably, access points are coupled to cable modems directly and not through a router; this allows the network manager to keep track of each cable modem, the access points connected to it, and all the wireless users connected to an access point. This in turn facilitates individual recognition of clients (user/computers) by the network manager so that it can, for example, allow services to follow a roaming client, rather than have services permanently associated with a particular cable modem.

The network manager tracks communications from a user and detects when that user roams from one cable modem to another. When such a change is detected, communications to the user are rerouted through the second modem. Preferably, the user communicates from the PC or user equipment to access point to cable modem without any router in between to facilitate user tracking. In a typical system, the network manager can reside in combination Cable Modem Termination System (CMTS) and WiFi switch. For wider coverage, plural network managers can communicate with each other to collectively manage user communications.

The present invention takes advantage of an existing cable-TV infrastructure to provide mobile broadband communications and Internet access. While new vendor and client equipment may be required, the invention relies primarily on existing cabling (and cabling that would added anyway to extend cable-TV coverage). Furthermore, the invention is compatible with standards that have already been implemented, like wireless 801.11, so users need not replace or upgrade their laptops, personal digital assistants, wireless enabled cell phones, etc., to avail themselves of most the invention's advantages. Finally, personal devices or devices built into vehicles can operate continuously under roaming conditions, with services following the user. These and other features and advantages of the invention are apparent from the description below with reference to the following drawings.

### BRIEF DESCRIPTION OF THE DRAWINGS

FIG. 1 is a schematic illustration of a network in accordance with the present invention.

FIG. 2 is a flow chart of a method in accordance with the present invention and employed in the network of FIG. 1.

FIGS. 3A, 3B, 4A, 4B, 5A, and 5B are screen shots of software used in the network of FIG. 1.

### DETAILED DESCRIPTION

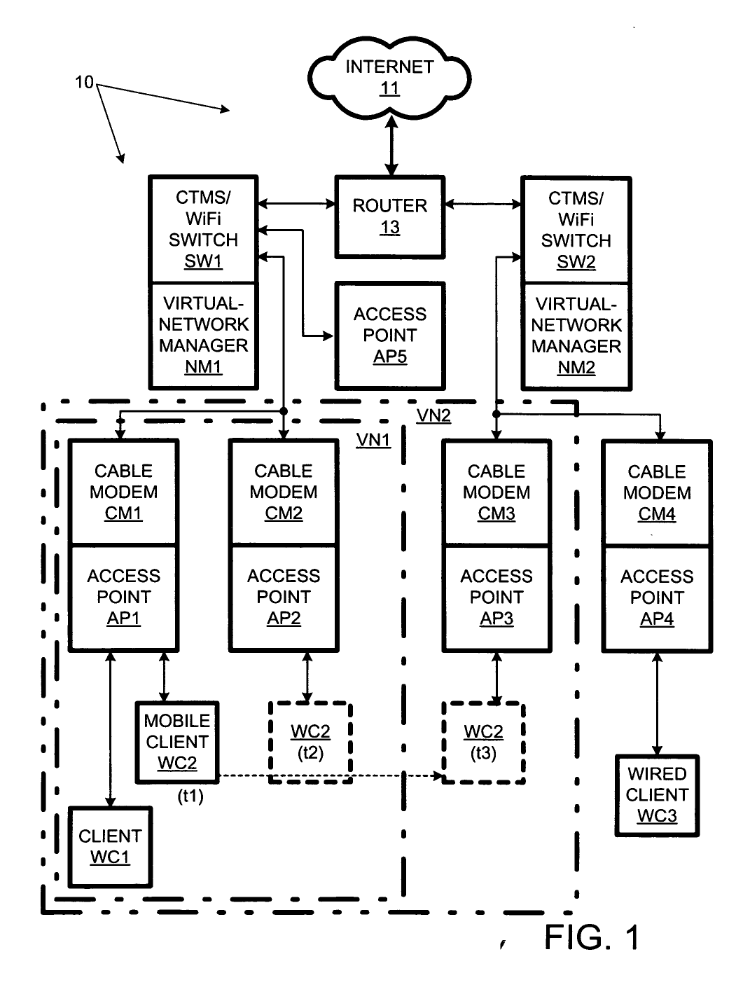

A system 10 in accordance with the invention is coupled to the Internet 11 at large as shown in FIG. 1. System 10 includes a router 13, switches SW1 and SW2, cable modems CM1-CM4, access points AP1-AP5, and clients WC1 and WC2. Switch SW1 provides for combined CMTS and WiFi switch functionality; these functions are managed in an integrated manner by virtual-network manager software NM1. Likewise, virtual-network manager software NM2 manages the combined CMTS and WiFi switch capabilities of switch SW2.

Cable modem CM1 is connected to wireless access point AP1. Conveniently, cable modem CM1 and access point AP1 can share a chassis, but the invention provides for separately housed cable modems and access points as well. Cable modems CM2-CM4 are similar and respectively coupled to wireless access points AP2-AP4. The absence of a router between cable modems and access points allows individual recognition of clients (user/computers) at switches SW1 and SW2. This allows services to follow a roaming client, rather than have services permanently associated with a particular cable modem.

Thus, when a wireless client (user and laptop computer) WC2 moves from the coverage area of access point AP1 at time t1 to the overlapping coverage area of access point AP2 at time t2, virtual network manager NM1 can detect this change and switch the connection between Internet 11 and client WC2 from a channel through cable modem CM1 to a channel through cable modem CM2. This switching can be effected without noticeably interrupting a session in which client WC2 is involved. Whether or not the coverage areas overlap, virtual network manager NM1 can reallocate services from cable modem CM1 to cable modem CM2. For example, bandwidth, content access, and quality of service features can follow a client, rather than be fixed to a cable modem. In effect, virtual-network manager NM1 defines a virtual network VN1 that encompasses the combined coverage areas of access points AP1 and AP2.

Switches SW1 and SW2 can communicate via router 13. This allows virtual-network managers to cooperate to define a virtual network VN2 that span beyond the coverage of either switch alone. Thus, when client WC2 moves from the coverage area of access point AP2 at time t2 to the coverage area of access point AP3 at time t3, a session can continue uninterrupted and services can be reallocated from switch SW1 and cable modem CM2 to switch SW2 and cable modem CM3.

As shown in FIG. 1, cable modem CM4, access point AP4, and client WC3 are outside virtual network VN2 even though services by one of the switches (switch SW2) that manages virtual network VN2. This illustrates the capability of virtual-network managers NM1 and NM2 to include or exclude connected cable modems from virtual networks. More generally, virtual networks can overlap in a variety of ways. For example, the virtual network for one client may not be the same for another client serviced by the same switch or switches.

In FIG. 1, each switch SW1, SW2, is shown with two cable modems attached. Generally, much larger numbers of cable modems would be attached to a single CMTS/WiFi switch. These would include cable modems within one or more virtual networks and as well cable modems excluded from virtual networks. For example, publicly operated access points and residential access points could be connected to cable modems coupled to a common CMTS. The public access points could be treated as a virtual network, while residential cable modems could be treated separately from the network.

In system 10, switches SW1 and SW2 are connected to cable modems CM1-CM4 using hybrid fiber and cable (HFC) connections. The invention provides further for switches and access points that have Ethernet connections for direct connections (e.g., without a cable modem). For example, switch SW1 connects to access point AP5 via a direct Ethernet connection. The switch can monitor all the relevant Ethernet, IEEE 802.11, Internet protocol, and RF parameters associated with the network so it can be monitored, managed, and configured. The switch can allow mobility between access points. Of course, some end users can also be connected directly to cable modems via Ethernet or other connection (e.g., USB).

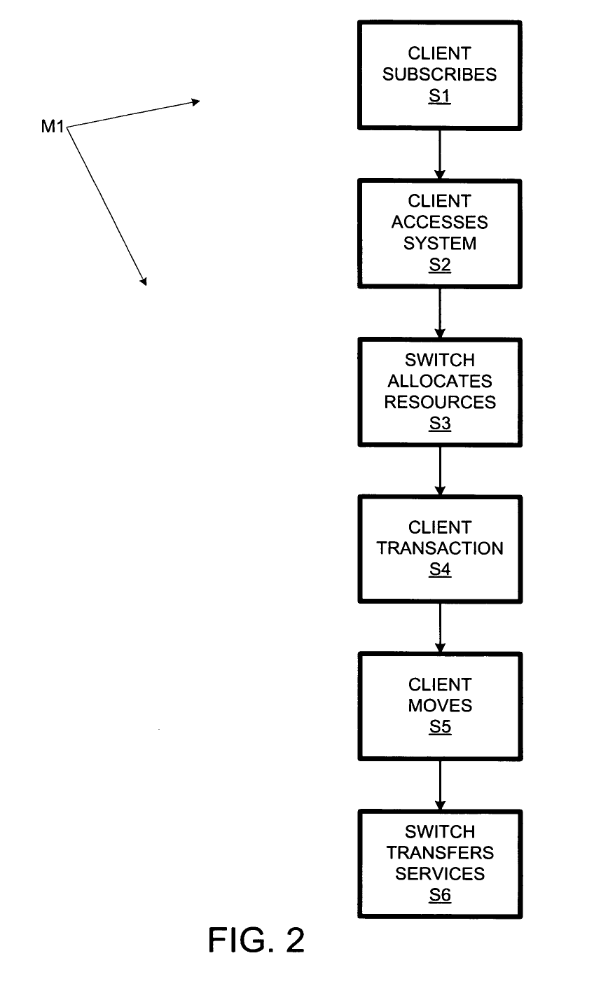

A method of the invention is flow charted in FIG. 2. At method segment S1, a client subscription is set up for a wireless client. At method segment S2, the wireless client requests Internet access via a first cable modem. At method segment S3, a switch SW1 allocates resources associated with the subscribed wireless client to the first cable modem. At method segment S4, the client engages in an Internet transaction, e.g., shopping, information gathering, communication.

At method segment S5, the wireless client moves to the coverage of an access point connected to a second cable modem. At method segment S6, the switch transfers the on-going session and services associated with the subscription so that they are accessible via the second cable modem.

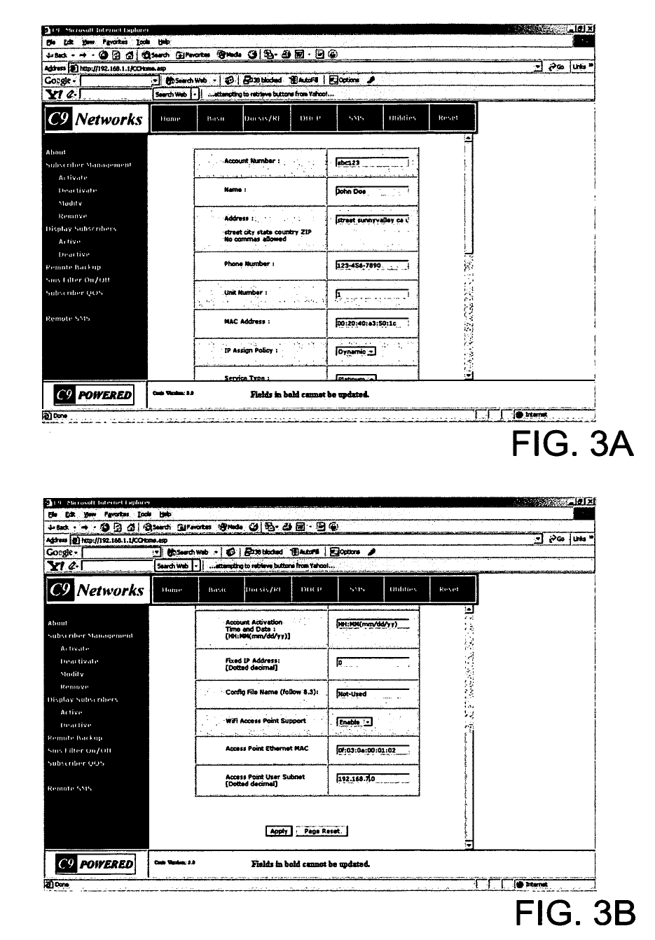

Virtual network manager NM1 includes a software tool called the Subscriber Management System (SMS) which is used to activate and deactivate cable modems and keeps the association between users (PCs etc.) access points and the cable modems to which they are connected. Virtual network manager NM2 likewise has an SMS. Each SMS is browser accessible. Some of the features are apparent from the screen shots of FIGS. 3A, 3B, 4A, 4B, 5A, and 5B.

In FIG. 3A, the cable modem MAC (media access control) address is being entered in to a SMS so as to activate the device. In the lower part of the same screen, shown in FIG. 3B, a cable modem can be defined as connected to a WiFi access point by choosing “WiFi Access point Support-Enable” and entering the WiFi access point's MAC address and also choosing the subnet for all wireless clients connected to that access point. This helps the system to now associate the CMTS data with the WiFi data. When this cable modem comes on-line the CMTS-WiFi DHCP (Dynamic Host Configuration Protocol) server recognizes the cable modem as that associated with an access point. It provides the IP address to the cable modem and then when the access point sends a DHCP request it will identify the access point and associate it with the cable modem described in FIGS. 3A and 3B. All wireless clients seen behind this cable modem/access point combination will be assigned the IP addresses as requested in last line of FIG. 3B which is subnet for the users on this access point. The system allows the operator to provide same IP subnet for all access points making mobility easier or assign separate IP subnet to each access point users.

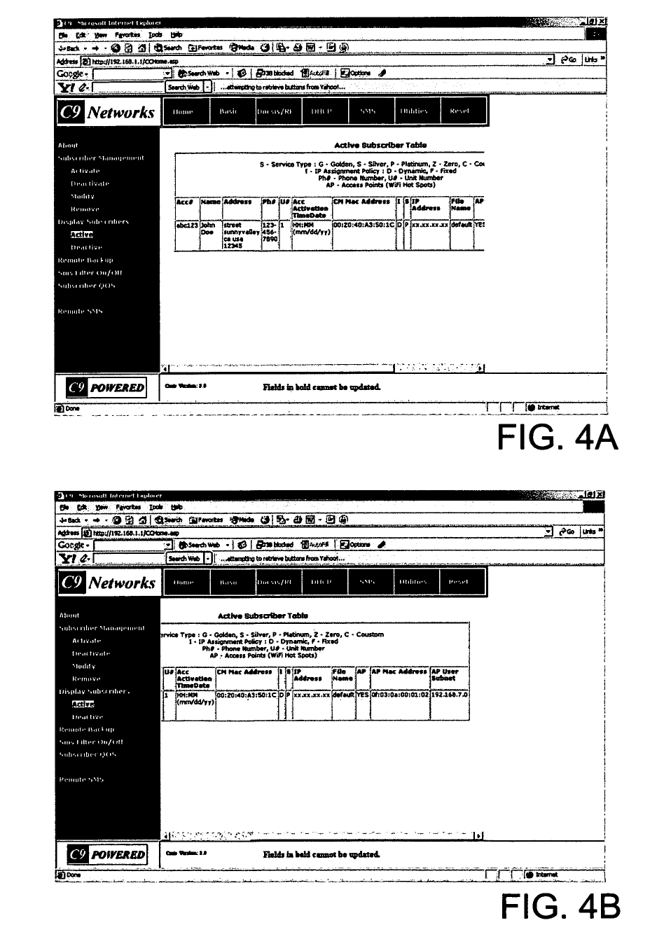

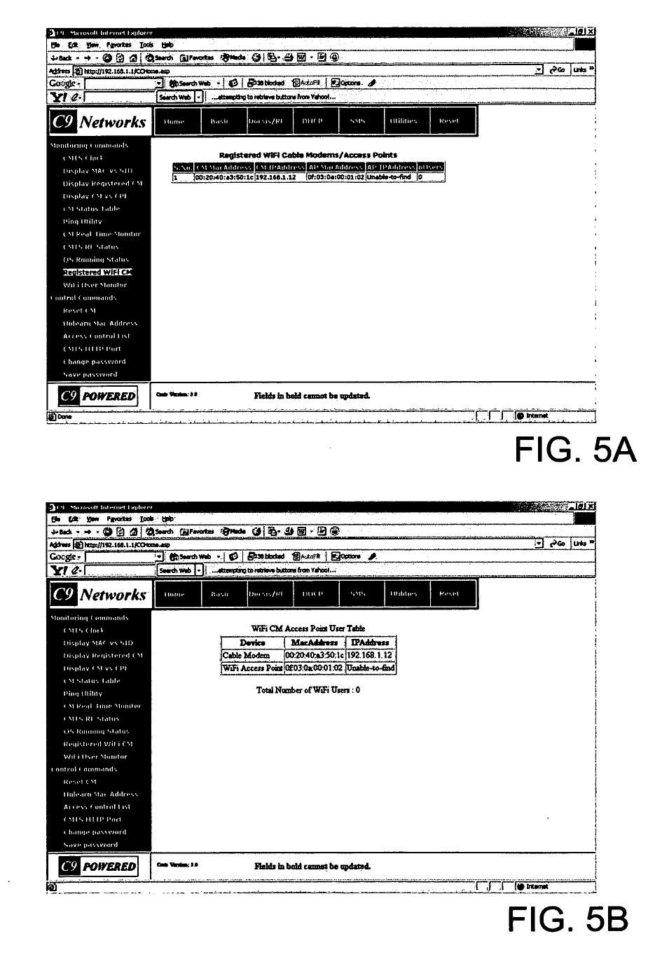

In FIGS. 4A and 4B the cable modem and access point parameters like MAC and IP (Internet Protocol) addresses entered in the SMS (Subscriber Management System) can be reviewed. This also allows the system to give static, dynamic IP addresses to any devices like cable modem, access point etc. It also allows the entire user set behind an access point being associated with a subnet called the “access point user Subnet” in FIG. 4B. Also wireless client behind one or more access points can get the same subnet or unique subnets. In FIG. 5A the cable modem and access point MAC address and IP addresses are shown. In FIG. 5B the users behind the access point will be displayed. The figures show that no wireless client was present at time of picture snap shot.

The invention provides a relatively low cost and flexible integrated CMTS-cable modem and Wifi network. The invention supports cable modems, access points over cable and, optionally, access points over Ethernet. The connections between the switches and the cable modems is riding on the Cable TV network or the last part of the network. The RF input/output of CMTS is combined with the traditional Cable TV feed at the headend. From there both TV and data flow on cable to the cable modems.

The network manager provides integrated control over the network via both cable modems and access points. The control can be performed remotely, e.g., using browser access of the virtual-network manager. Considerable freedom is provided to configure, manage, and monitor virtual networks. For this reason, security measures are easier to implement than they would be if the CMTS and WiFi aspects were separate. The virtual network manager can access SNMP (Simple Network Management Protocol) MIBs (Management Information Base) in cable modems and access points. The network manager can associate cable modems, access points, wired clients, and wireless clients and their properties; this can be used to facilitate debugging or to identify and isolate hackers and rogue devices.

Virtual networks can be configured on a per-cable-modem basis. Cable modems can be grouped into subnets to provide for flexible roaming capability or kept separate to enhance security. For example, cable modems connected wired clients can be kept on subnetworks that exclude cable modems connected to to wireless access points, since it is easier to hack into a wireless system than a wired network.

The invention economically enables networks on the scale of a cable provider's subscription base, e.g., on the scales of cities, buildings, building complexes, malls, airports, store chains, etc. Wireless users within a virtual network can roam and maintain their subscription features and, where access coverage overlaps, uninterrupted interactive sessions. These and other modifications to and variations upon the disclosed embodiments are provided for by the present invention, the scope of which is defined by the following claims.

What is claimed is:

1. A system comprising:
plural wireless access points;
plural cable modems respectively connected to said access points;
a switch connected to said cable modems and to an external network, said switch including a network manager that associates the identity of a wireless client communicating with said external network through at least one of said access points, at least one of said cable modems, and said switch, with the identity of said at least one of said cable modems.

2. A system as recited in claim 2 wherein said network manager defines a subnet including more than one of said cable modems and excluding at least one of said cable modems.

3. A network appliance comprising:
an external network interface for coupling to an external network;
a cable-TV modem interface for coupling to wireless access points via cable modems; and
a network manager that associates the identity of a wireless client communicating with said external network through at least one of said access points with the identity one of said cable modems coupled to said at least one of said access points.

4. A network appliance as recited in claim 3 wherein said network manager defines a subnet including more than one of said cable modems and excluding at least one of said cable modems.

5. A method comprising:
detecting when a wireless client moves from a first coverage area of a first wireless access point connected to a first cable modem to a second coverage area associated with a second wireless access point connected to a second cable modem; and
shifting services assigned to said first cable modem to said second cable modem so that said services remain assigned to said wireless client.

6. A method as recited in claim 5 further comprising, prior to said shifting, configuring a subnetwork including said first and second cable modems.
